(19) United States
(12) Patent Application Publication
(10) Pub. No.: US 2024/0215763 A1
(43) Pub. Date: Jul. 4, 2024

(54) HAND VEGETATION GRINDER ASSEMBLY AND METHODS OF USE

(71) Applicant: Ricky Perrier, JR., MARQUETTE, MI (US)

(72) Inventor: Ricky Perrier, JR., MARQUETTE, MI (US)

(21) Appl. No.: 18/402,699

(22) Filed: Jan. 2, 2024

Related U.S. Application Data
(60) Provisional application No. 63/436,645, filed on Jan. 2, 2023.

(51) Int. Cl. A47J 42/34; A47J 42/40

(52) U.S. Cl. CPC A47J 42/34; A47J 42/40

(57) ABSTRACT

A hand vegetation grinder assembly comprising a collector, a grinder, and optionally a lid for grinding a vegetation mass into smaller vegetation shreds. The grinder utilizes a grinder mesh that is substantially hemi-spherical and has grinder openings between woven wire for the shreds to fall through. Finger pressure is utilized to forcefully drive the vegetation across the mesh in a translating motion. The collector in some embodiments is a jar utilized to collect the vegetation shreds. The lid is utilized to enclose the jar keeping the vegetation fresh. The size of the mesh has been optimized for best results. The grinder mesh is secured to a grinder ring for securing the grinder at the top of the collector.

This application claims priority to Provisional Patent Application No. 63/436,645 filed Jan. 2, 2023, the entire disclosure of which is hereby incorporated by reference and relied upon.

### BACKGROUND OF THE INVENTION

Field of the Invention. The invention relates generally to tools for the grinding of vegetation, and more particularly to vegetation and other food grinders, herb grinders, and their methods of use. FIG. 19 depicts some of the term definitions known in the art regarding mesh. For example, ‘mesh centers’ refers to the center of one wire to the center of the next parallel wire. ‘Wire diameter’ refers to the measurement of the entire wire from one side to the other. This is usually expressed as a number within three decimal places. ‘Mesh opening’ refers to the measurable distance between two parallel wires. ‘Lineal inch’ refers to the measurable distance in one inch. ‘Mesh count’ refers to the number of openings that can be counted in one lineal inch. An example of a 4×4 mesh having 25 inch centers is also depicted in FIG. 19. Additional definitions for these materials are noted here.

### Definitions

CALENDERED WIRE CLOTH—Wire cloth which has been passed through a pair of heavy rolls to reduce the thickness of the doth or to flatten the intersections of the wires and provide a smooth surface. Also called “rolled”.

COUNT—The number of openings in a lineal Inch.

CRIMP—Corrugations in wires to lock them in place.

DOUBLE CRIMP—Corrugations in both warp and shute wire to lock wires into position.

FILL WIRE—See “shut Wires”

FLAT TOP—A weave in which all crimps are on the underside of the cloth, thus providing a smooth surface.

GAUGE—Measure of wire diameter. The actual wire diameter should always be specified in decimal sizes.

INTERMEDIATE (INTER) CRIMP—Extra crimps in warp and fill wires between intersections. Most often used in wide mesh to assure accurate openings.

LOCK CRIMP—A weave in which deep crimps in wires at points of intersection lock wires securely in place. Usually specified for heavy duty screening.

LONG SLOT (Slotted)—A weave in which shute wires are arranged in clusters to provide slotted rectangular openings.

MARKET GRADE—The most popular wire cloth specifications selected for general purpose work.

MESH—When the mesh is specified as a number, it refers to the number of openings in a lineal inch measured from the center of one wire to a point 1″ distant.

OBLONG MESH—Wire cloth with rectangular openings. Usually called off count in the case or finer meshes.

PLAIN WEAVE—Wire cloth in which each warp wire and each shute wire passes over one and under the next adjacent complementary wire in both directions.

PLAIN DUTCH WEAVE—The same as “plain weave” except that the warp wires are usually larger than shute wires, and the shute wires are closely spaced, resulting in a dense weave with tapered or wedge shaped openings.

SELVAGE—A finished edge to prevent unraveling of wire cloth.

SHUTE WIRE—Wires running across the width of the cloth as woven. Also known as Weft or “fill wires”.

SPACE OPENING—The clear openings or space between adjacent parallel wires.

SQUARE MESH—Wire cloth with mesh count the same in both directions.

STRANDED WEAVE—Wire cloth with a twilled weave of multiple wires in both warp and shute.

TWILLED WEAVE—Wire cloth in which each warp wire and each shute wire passes successively over two and under the next adjacent pair of wires.

TWILLED DUTCH WEAVE—A combination of “Plain Dutch Weave” and “Twilled”; except that the warp and shute wires are usually the same size.

TWILLED DUTCH DOUBLE WEAVE—Same as “Twilled Dutch” except that the shute wires are smaller and overlap, thus increasing the number of shute wires in a lineal inch to provide greater density.

WARP WIRES—Wires running the length of the cloth as woven.

WELDED WIRE MESH—Has intersecting rows and columns of wire that are resistance welded at the intersection to form a grid. Because the wires are fused together, the mesh is incredibly strong and rigid ensuring a long lasting product.

WIRE CLOTH—is an arrangement of woven metal wires creating very small to medium uniform openings. Many different specifications are available which are used for various applications.

WIRE MESH—is an arrangement of thicker woven metal wires creating larger uniform openings. Many different diameters and weave constructions are available which are used for various applications.

TYPE 304 STAINLESS STEEL is an excellent basic Stainless and is often referred to as 18-8 Stainless, meaning 18% Chromium and 8% Nickel. It is the most commonly used grade in wire cloth and operates to approx. 1500 degrees F.

TYPE 316 STAINLESS STEEL has an addition of at least 2% Molybdenum that is more corrosion resistant than TYPE 304. It has better resistance in salt water and chlorine salts. Its strength is also increased at higher temperatures.

Type 304 & Type 316 Stainless Steel are also available in a different grade with decreased carbon content for additional corrosion resistance. They are referred to as “L” as in Type 304L or 316L or sometimes ELC (extra low carbon).

CARBON STEEL is a steel alloy where carbon is the main alloying element. The higher the carbon content, the more abrasion resistant the mesh. The standard selections are C1008 (low carbon), C1045 (high carbon), and C1065 (oil tempered).

ALUMINUM is a light malleable silvery metal that resists corrosion and oxidation which make it very popular in fencing applications. Aluminum also has good electrical and thermal conductivity and has high reflectivity as well.

BLACK EPOXY COATED STEEL is an exterior coating compound consisting of two distinct elements: an epoxy resin and a polyamine hardener. When the epoxy coating is fully cured, the resulting product is a durable, rigid plastic coating that is typically applied to plain steel.

HARDWARE CLOTH is a flexible wire-mesh material consisting of welded wires in a simple rectangular grid with a zinc coating to prevent corrosion. It is available is various openings and wire diameters as well as a selection of woven varieties.

TYPE 321 STAINLESS is 9-12% Nickel and 17-19% Chromium that also contains Titanium. This alloy is not recommended when welding is a requirement. This alloy has superior resistance to inter granular.

TYPE 330 STAINLESS with 35% Nickel and 17% Chromium is excellent for high temperature use to approximately 1900 degrees F. This alloy is good for heat treating baskets, etc., and is much lower in cost than Inconel 600.

400 SERIES STAINLESS with the addition of approximately 11% Chromium (no nickel) to carbon steel allows the mesh to be called Stainless steel with the added features of magnetic properties.

TYPE 410 STAINLESS has approx. 12% added Chromium (no nickel) to a carbon steel base. This gives a magnetic base to the metal with mild corrosion resistance. It can be used up to approximately 1400 degrees F. It can rust due to steel base makeup.

TYPE 430 STAINLESS has approx. 16 to 18% Chromium (no nickel) to a carbon steel base. This gives a magnetic base to the metal with mild corrosion resistance. It can rust due to its steel base.

COPPER is a base metal that is strong, easily formed and fatigue resistant. It has excellent electrical and thermal conductivity and good corrosion resistance in most alkaline solutions and organic chemicals.

HIGH BRASS is nominal 70% Copper and 30% Zinc. It has high strength and is ductile for severe cold working. It has mild corrosion resistance. Also known as Alloy 270.

LOW BRASS is nominal 80% Copper and 20% Zinc. This alloy has good corrosion resistance. Also known as Alloy 240.

COMMEROAL BRONZE is a 90% Copper and 10% Zinc alloy of excellent corrosion resistance. It is sometimes used in areas where salt air is present.

PHOSPHOR BRONZE is nominal 94% Copper, 4.75% Tin, and 0.25% of Phosphorus. It has a strong alloy and offers excellent resistance to fatigue. It is resistant to corrosion from sea water but must not be used with strong oxidizing agents.

MONEL 400 is a corrosion resistant alloy of copper and nickel. It is excellent when used in sewage disposal and where toughness is also required. It stands up well in salt, alkali, food and beverages. The nominal content is 66% Nickel and 30% Copper.

NICHROME has a minimum of 57% Nickel and approx. 16% Chromium that resists scaling at high temperatures usually up to 1875 F. NICHROME Vis good up to 2150 F due to it's composition of 80% Nickel and 20% Chromium.

INCOLOV 800 operates in approx. 1200 to 1600 F. This alloy contains approximately 32% Nickel and 20% Chromium and reacts similar to TYPE 330 Stainless.

ALLOY 1100 is a pure form of Aluminum where corrosion resistance is more important than strength.

HAST ALLOY A is resistant to cyanide salts even at high temperatures, making it an ideal alloy for heat treating baskets.

HAST ALLOY B is useful in Hydrochloric acid in most concentrations. This alloy is not to be used in high temperatures. This material is excellent for pickling baskets.

HAST ALLOY C—276 is good for wet Chlorine gas as well as ferric and cupric chloride. This alloy also has higher temperature properties up to 1800 F range. This alloy also has strong corrosion resistance to oxidizing agents.

INCONEL 600 is meant for high temperatures up to 2000 F due to 72% min. Nickel and 15% nominal Chromium content. This alloy is slow to carburize at high temperatures.

TANTALUM is comparable to glass in resisting corrosion and is inert to most acids except hydrofluoric acid and alkalis. It is compatible with body tissue and often used in implants. The physical properties compare to mild steel.

### SUMMARY OF THE INVENTION

Disclosed herein is a hand vegetation grinder assembly and methods of its use.

In one form, a hand vegetation grinder assembly comprises a collector and a grinder.

In one form, the collector is in the form of a jar.

In one form, the collector is manufactured from glass, a metal, or a polymer.

In one form, the collector comprises a collector wall.

In one form, the collector wall comprises a central axis A.

In one form, the collector wall comprises an inner collector surface.

In one form, the inner collector surface defines a collector cavity inside the collector operable to contain vegetation pieces.

In one form, the collector wall comprises an outer collector surface facing outward in an operable mode/configuration.

In one form, the collector wall comprises a base face for supporting the collector on a horizontal surface.

In one form, the base face is substantially planar.

In one form, the collector wall comprises a receiver face.

In one form, the receiver face faces upwards in an operable mode.

In one form, the receiver face is generally horizontal in an operable mode.

In one form, the receiver face is generally planar.

In one form, the receiver face defines a collector mouth that opens into the collector cavity.

In one form, the collector mouth is circular.

In one form, the outer collector surface below the receiver face is threaded.

In one form, the hand vegetation grinder assembly comprises a collector, a grinder, and a lid.

In one form, the lid encloses the collector mouth and can seal the collector cavity.

In one form, the lid encloses the collector mouth with the grinder positioned between the lid and collector.

In one form, the collector wall comprises a transition zone wherein the collector increases in diameter moving inferiorly from the collector mouth.

In one form, the hand vegetation grinder assembly comprises an operable mode whereby its central axis is vertical and the grinder is seated on top of the receiver face of the collector and aligned along the central axis.

In one form, the hand vegetation grinder assembly comprises a removed mode whereby the grinder is removed from the collector.

In one form, the grinder comprises a grinder ring.

In one form, the grinder ring comprises a generally flat superior facing superior face in the operable mode.

In one form, the grinder ring comprises a generally flat inferior facing inferior face in the operable mode.

In one form, the grinder ring comprises an inner face facing the central axis of the grinder ring.

In one form, the grinder ring comprises an outer face facing outward opposite the inner face.

In one form, the grinder comprises a grinder mesh.

In one form, the grinder mesh is made of steel, preferably stainless steels such as type 304, 304L, 316, 316L, and type 430.

In one form, the grinder mesh is constructed of woven wires.

In one form, the grinder mesh is at least partially hemi-spherical.

In one form, the grinder mesh is substantially rounded or bulbus.

In one form, the grinder mesh comprises a fixation face at a circular edge of the grinder mesh.

In one form, the fixation face is generally planer.

In one form, the central axis of the grinder mesh and the central axis of the circular ring are aligned such that the fixation face of the grinder mesh is aligned with the inferior face of the grinder ring.

In one form, at least a portion of the fixation face of the grinder mesh is welded to the inferior face of the grinder ring.

In one form, the inner face of the grinder ring defines a grinder mouth that leads into a grinder cavity defined by the inner grinder face.

In one form, the inner grinder face is opposed to the outer grinder face which faces outward.

In one form, a vegetation mass moved across the inner grinder face is shredded into vegetation shreds that pass through grinder openings before falling into the collector cavity.

In one form, a grinder ring comprises a crimp space encircling the grinder ring.

In one form, a mesh flange extends radially outward from a grinder mesh and is crimped within the crimp space for fixation thereto to resist forces imparted on the grinder mesh when shredding vegetation.

In one form, a preferred embodiment for a method of using a hand vegetation grinder assembly as disclosed herein comprises the following steps. Obtaining a collector having: a collector wall defining a substantially enclosed collector cavity, a base face for supporting the collector on a horizontal supporting surface such as a countertop, and a receiver face that defines a collector mouth for supporting a grinder and providing entry into the collector cavity. Obtaining a grinder comprising a grinder ring with a generally semi-spherical or bulbus grinder mesh made of woven wire and wherein a fixation face of the grinder mesh is fixed to an inferior face of the grinder ring or crimped between opposing surfaces of the grinder ring. Placing the base face of the collector on the supporting surface. Aligning the central axis of the grinder with the central axis of the collector and lowering the grinder such that the inferior face of the grinder ring is seated on the receiver face of the collector and the grinder mesh occupies the collector mouth of the collector. At least partially filling the grinder cavity with a vegetation mass or other food product. Grasping the vegetation mass with the user's fingers, and applying pressure to the vegetation mass towards the grinder mesh while moving the vegetation parallel to the mesh surface causing consequent shearing of pieces of the vegetation (vegetation shreds) to fall through the grinder openings in the grinder mesh and collecting the vegetation shred in the collector cavity. Removing the grinder from the collector. Removing the food/vegetation from the collector cavity and utilizing the ground food or vegetation product as desired.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a top perspective view of a hand vegetation grinder assembly which in some embodiments can include a lid;

FIG. 2 depicts a top perspective exploded view of a hand vegetation grinder assembly wherein a grinder has a diameter configured to seat in a collector mouth;

FIG. 3 depicts a cross-sectional view through plane B of a hand vegetation grinder assembly;

FIG. 4 depicts a cross-sectional view through plane B of a hand vegetation grinder assembly having a different size than that of FIG. 3 for fit in a different size collector;

FIG. 5 depicts a top perspective view of a grinder ring of a hand vegetation grinder assembly;

FIG. 6 depicts a top perspective view of a grinder mesh of a hand vegetation grinder assembly, together FIG. 5-6 depict an exploded view of a grinder;

FIG. 7 depicts a side cross-sectional view of the grinder in FIG. 2;

FIG. 8 depicts a bottom perspective cross-sectional view of the grinder in FIG. 2 wherein the grinder mesh is welded to a grinder ring;

FIG. 9 depicts a top perspective cross-sectional view of the grinder in FIG. 2;

FIG. 10 depicts an embodiment of a grinder wherein the grinder ring is formed to crimp over the grinder mesh;

FIG. 11 depicts a cross-sectional view through Plane B of the grinder of FIG. 10;

FIG. 12 depicts a close-up cross-sectional view through the grinder ring of FIG. 10;

FIG. 13 depicts a bottom view of the grinder ring used in the FIG. 10 embodiment;

FIG. 14 depicts a bottom perspective view of the grinder of FIG. 10;

FIG. 15 depicts a cross-sectional view through a hand vegetation grinder assembly demonstrating the hand of a user grinding vegetation;

FIG. 16 is a diagram depicting a method for using a hand vegetation grinder assembly;

FIG. 17 depicts examples of mesh known in the prior art that can be used in a grinder of a hand vegetation grinder assembly;

FIG. 18 depicts some of the various construction styles for mesh known in the prior art;

FIG. 19 depicts terms known in the art for specifying wire mesh.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

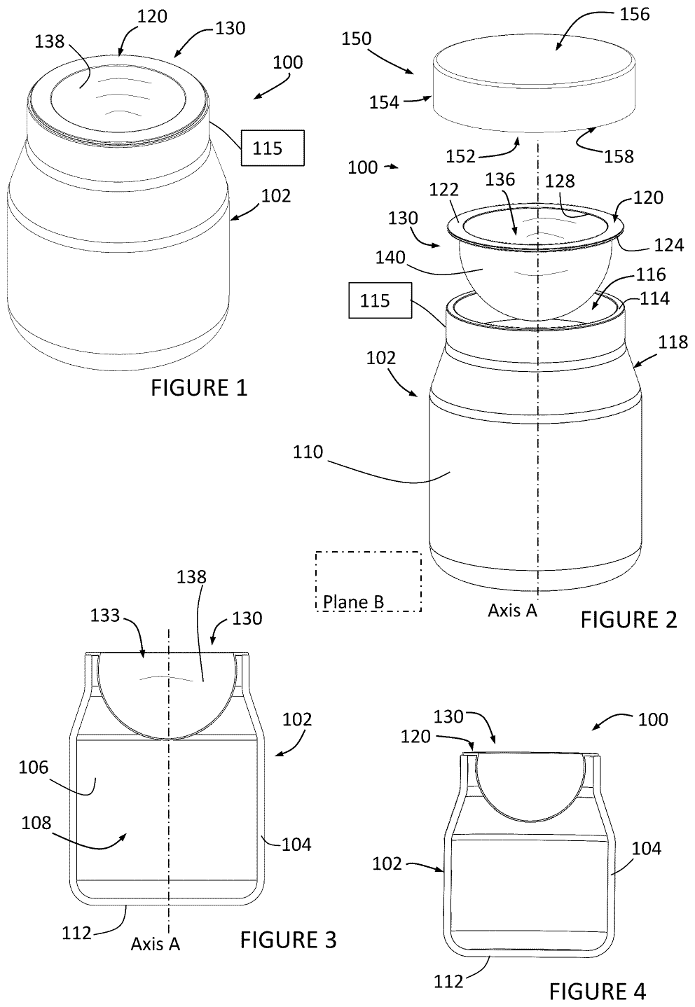

Disclosed herein are embodiments of a hand vegetation grinder assembly and methods of its use. As depicted in FIG. 1 with a cross sectional view in FIG. 3, a hand vegetation grinder assembly 100 comprises a collector 102 and a grinder 130. In preferred forms, the collector is in the form of a jar as depicted in FIGS. 1-4 and can be made from a variety of materials including but not limited to glass, metals, and polymers. The collector can be of a variety of sizes as noted in FIGS. 3 and 4 whereby the collectors are illustrated as varied heights with collector mouths of varied diameters.

As noted in the Figures, the collector 102 comprises a collector wall 104. The collector will typically have a central axis A. The collector wall 104 comprises an inner collector surface 106 on an inner aspect of the collector wall 104. The inner collector surface 106 defines a collector cavity 108 inside the collector 102 which in most cases is round/cylindrical but can assume other profiles commonly seen with jars. The collector wall 104 also comprises an outer collector surface 110 on the outer aspect of the collector wall. The collector wall 104 comprises a base face 112 on its base for supporting the collector 102 on a horizontal surface such as a table. The base face 112 is substantially planar in this embodiment.

The collector wall 104 comprises a receiver face 114 which faces upwards and is generally horizontal and generally planar. The receiver face 114 defines a collector mouth 116 that opens into the collector cavity 108. The collector mouth 116 is substantially circular. The outer collector surface 110 below the receiver face 114 can be threaded 115 and can thread with a lid 150 if so desired to create a seal between the threaded lid and the collector. In an alternative embodiment, the lid, or the collector or both are non-threaded whereby the lid simply holds its position by gravity. In this embodiment, the hand vegetation grinder assembly 100 comprises a collector 102, a grinder 130, and a lid 150. In other embodiments, the hand vegetation grinder assembly is absent a lid 150 to enclose the collector mouth. In some embodiments, the lid 150 encloses the collector mouth 116 with grinder 130 positioned between the lid 150 and collector 102 as illustrated in the exploded view of FIG. 2. In FIG. 1, the hand vegetation grinder assembly is illustrated without a lid.

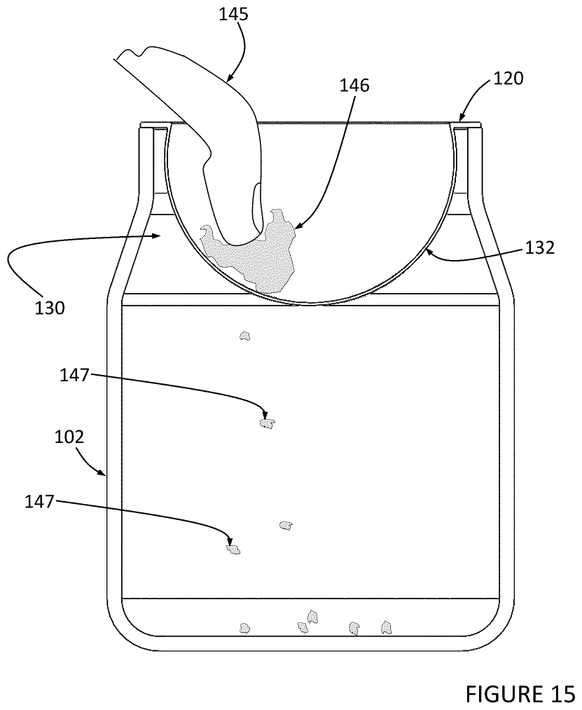

In some embodiments, as noted in FIG. 2, the collector wall 104 comprises a transition zone 118 wherein the collector 102 increases in diameter moving inferiorly from the collector mouth 116. Also noted here, the hand vegetation grinder assembly 100 comprises an operable mode whereby its central axis A is vertical and the grinder 130 is seated on top of the receiver face 114 of the collector 102. In another state, the hand vegetation grinder assembly 100 comprises a removed mode whereby the grinder 130 is removed from the collector 102. The removed mode can be used to access vegetation shreds 147 that have been ground by opposed finger 145 forces causing the vegetation to translate across the grinder mesh 132 from a vegetation mass 146 and fallen through grinder openings 135 into the collector cavity 108 (FIG. 15).

Some embodiments can include a lid 150 to seal the collector 102 with or without the grinder 130 seated within the collector mouth 116. The lid comprises a closure wall 156 which is typically planar with a radial wall 154 extending downward from the closure wall defining a closure cavity 152 in which the collector mouth 116 is placed. Threads 115 on the outside of the collector and inner threads 158 encircling the closure cavity can be used to create a sealed closure over the collector when the lid is advanced over the collector mouth.

As depicted in FIGS. 5-9, the grinder comprises a grinder ring 120 fixed to a grinder mesh 132. The grinder ring 120 comprises a generally flat superior facing superior face 122 and a generally flat inferior facing inferior face 124 in the operable mode. The grinder ring 120 also comprises an inner face 128 facing the central axis of the grinder ring and an outer face 126 opposite the inner face 128.

Further to these illustrations, the grinder 130 comprises a grinder mesh 132 which is made of steel, preferably stainless steels such as type 304, 304L, 316, 316L, and type 430 but can be constructed from other materials. Here the grinder mesh 132 is constructed of woven wires 134 defining grinder (mesh) openings 135 that provide for the passage of ground vegetation.

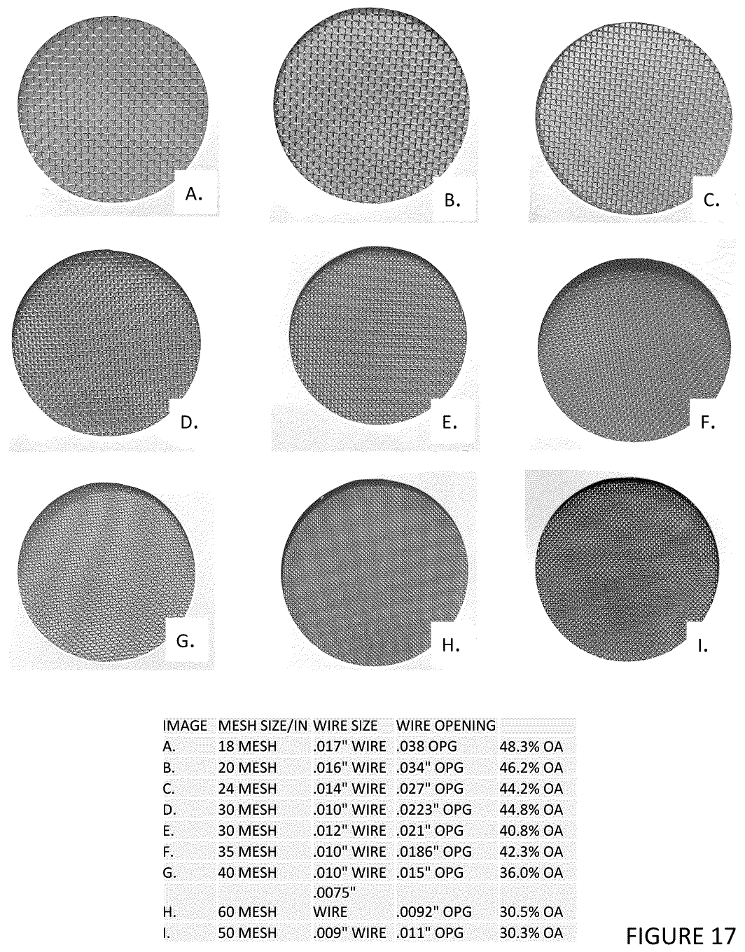

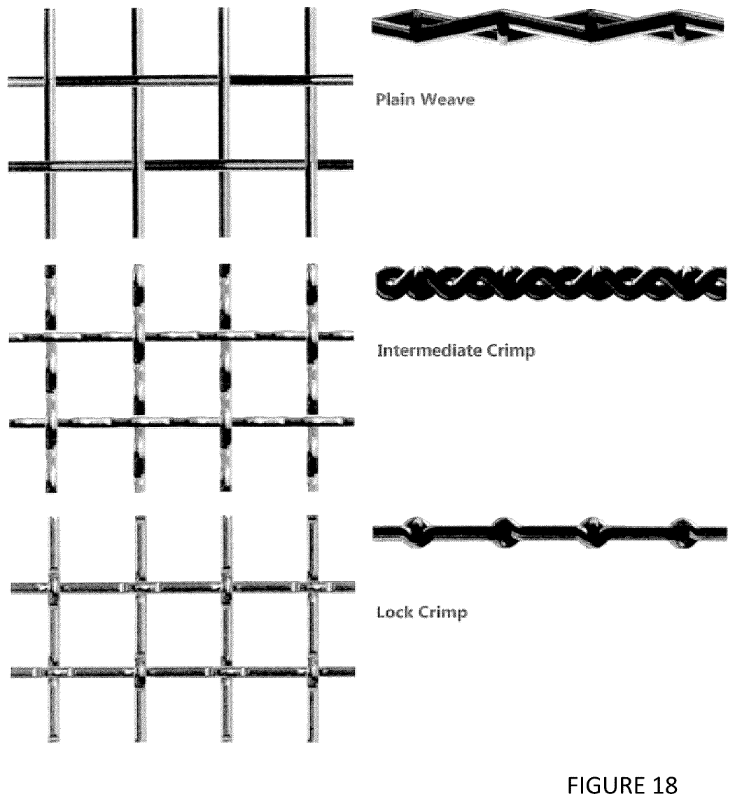

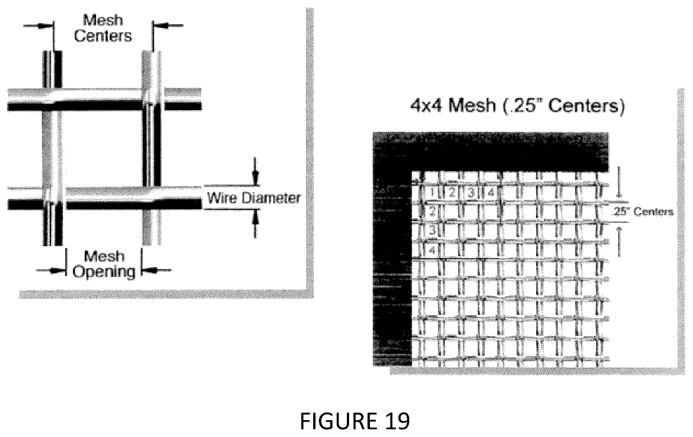

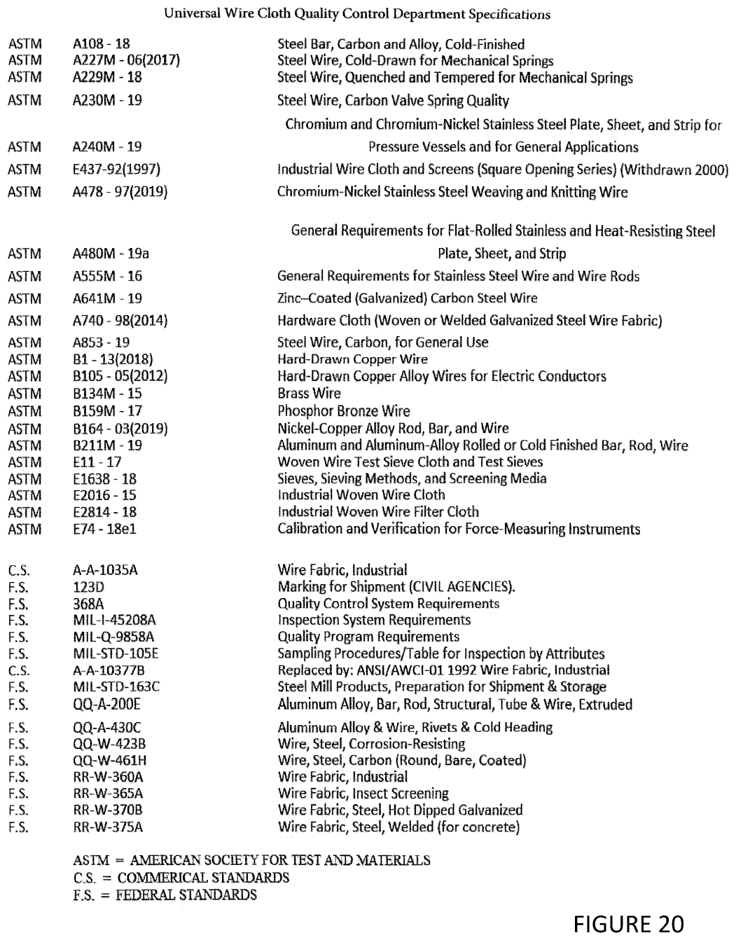

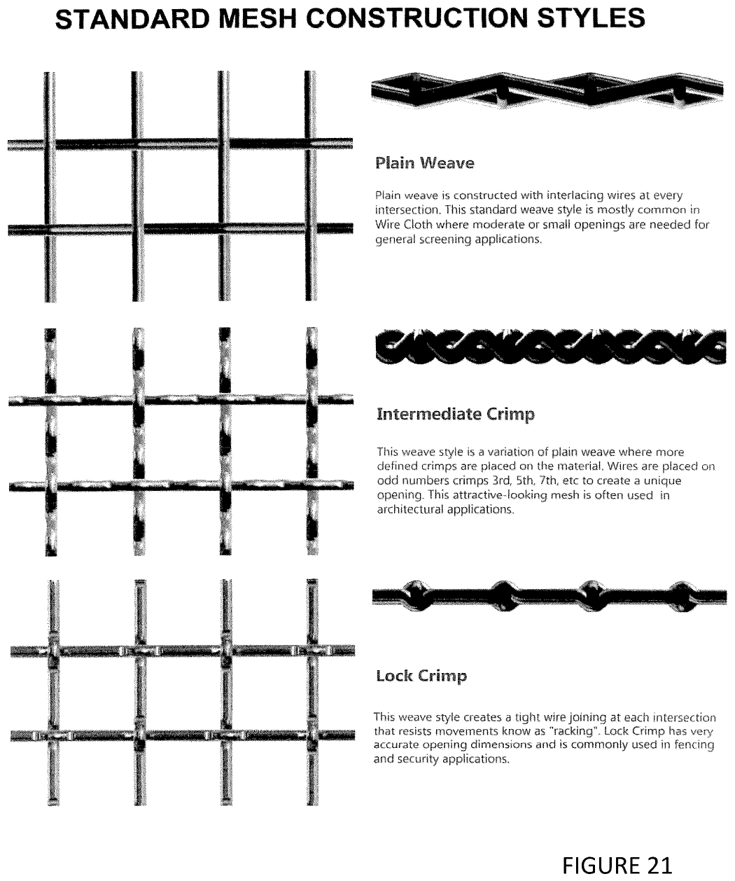

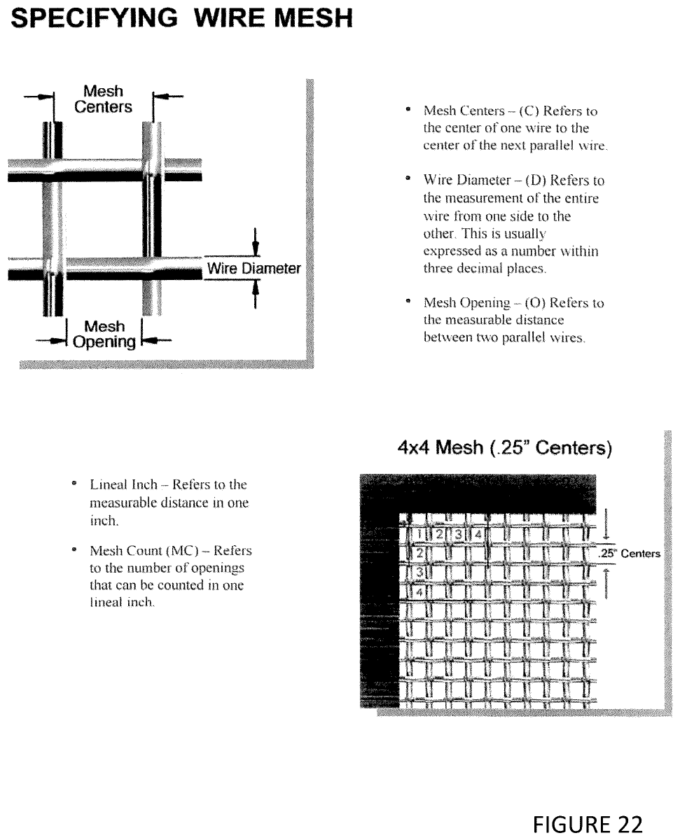

FIG. 17 depicts a wide variety of woven grinder meshes with varying wire diameters and mesh openings between the weaved wires. Those skilled in the art will recognize that other wire diameters, mesh openings, and weave types can be used. Definitions as known in the art to describe these variations are described in FIGS. 18 and 19. Industry standards for various wire meshes (wire cloth) are noted in FIG. 20. Examples of standard mesh construction styles and specifications for describing wire mesh are described in FIG. 21-22.

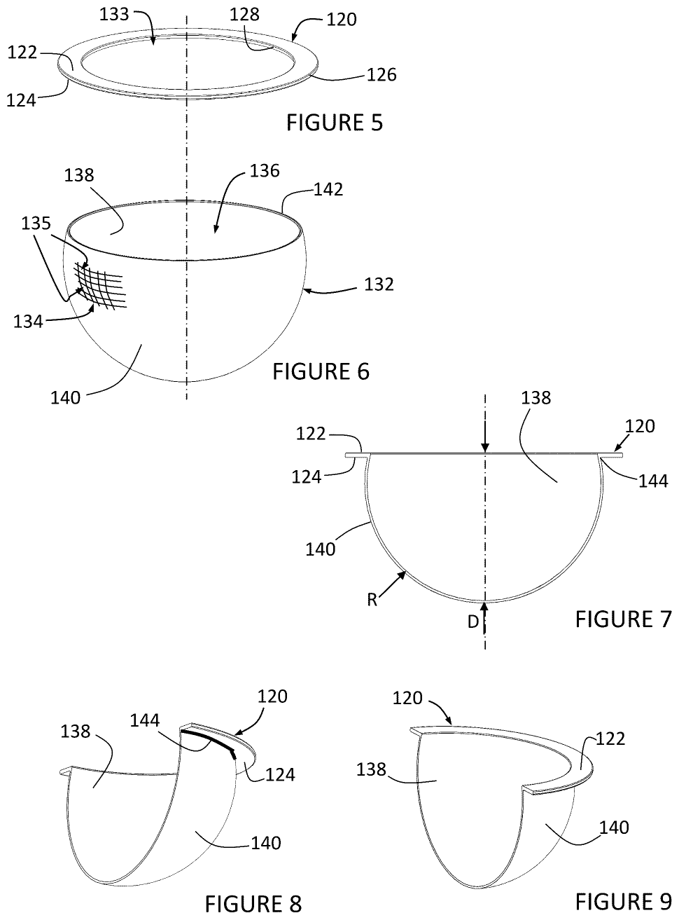

As noted in FIGS. 6-9, the grinder mesh 132 is generally described as hemi-spherical, bulbus, or round, however, other profiles preferably defining a continuous surface can be used. The grinder mesh 132 comprises a fixation face 142 at a circular edge of the grinder mesh 132. The fixation face 142 is generally planer. The central axis of the grinder mesh 132 and the central axis of the grinder ring 120 are aligned such that the fixation face 142 of the grinder mesh 132 is aligned with the inferior face 124 of the grinder ring 120. At least a portion of the fixation face 142 of the grinder mesh 132 is fixed using a weld 144 in this embodiment. Alternatively, other means known in the art can be used to secure the inferior face 124 of the grinder ring 120 to the fixation face 142. The grinder 130 is typically sized such that the grinder ring 120 is supported by the receiver face of the collector and the grinder mesh 132 resides through the collector mouth 116.

The grinder mesh as depicted in FIG. 7 for example, has steeply sloped sides that curve inward to an inferior point. This steep slope, rather than a flat horizontal mesh, provides for longer sweeping grinding motions that have proven to be more effective for grinding. For example, in one embodiment for use on collectors having a collector mouth of about 2.5″ (inches), the grinder mesh 132 has a radius ‘R’ of just over 1″ and bulges below grinder ring 120 approximately 1.28″. As another example, for use on collectors having a collector mouth of about 3.0″, the grinder mesh 132 has a radius ‘R’ of 1.34″ and bulges below grinder ring 120 about 1.6″ deep. Although the specifications of the grinder mesh can vary, #24 mesh, 304 stainless steel, having a 0.027″ opening (OPG) has been effectively utilized in testing.

The inner face 128 of the grinder ring 120 defines a grinder mouth 133 that leads into a grinder cavity 136 defined by the inner grinder face 138. The inner grinder face 138 is opposed to the outer grinder face 140 as depicted in the Figures. Moving vegetation across the inner grinder face 138, shears off parts of the vegetation mass 146 causing it to fall through the grinder openings 135 (mesh orifices) formed between woven wire 134 into the collector.

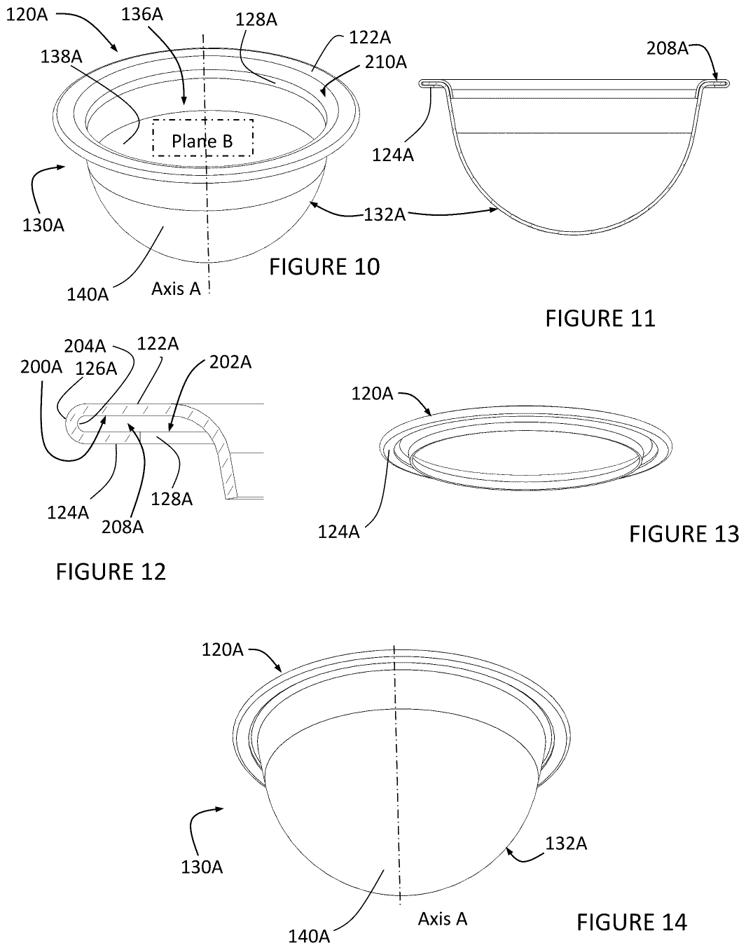

FIGS. 10-14 depict another embodiment of a grinder 130A which can be used within a hand vegetation grinder assembly. In this embodiment, grinder ring 120A is also ring shaped and is in the form of a crimp configured to crimp over grinder mesh 132A. As before, the grinder ring 120A comprises a superior face 122A that faces upwards in an operational configuration, an inferior face 124A that faces downwards, an inner face 128A that faces the central axis, and an outer face 126A that faces away from the central axis. A superior crimp face 200A is spaced and opposed with inferior crimp face 202A with inter-crimp face 204A extending therebetween to define crimp space 206A. The grinder mesh 132A in this embodiment, comprises a substantially horizontal mesh flange 208A that is seated circumferentially in crimp space 206A. Opposed crimping forces directed at superior face 122A and inferior face 124A of grinder ring 120A deform the ring to tightly secure the mesh flange 208A within the crimp space 206A. This provides just one example of an alternative construction to the welded approach as depicted in FIG. 8. As depicted in FIG. 10, grinder ring 120A comprises a soft entry 210A due to the radiused edge of grinder ring 120A.

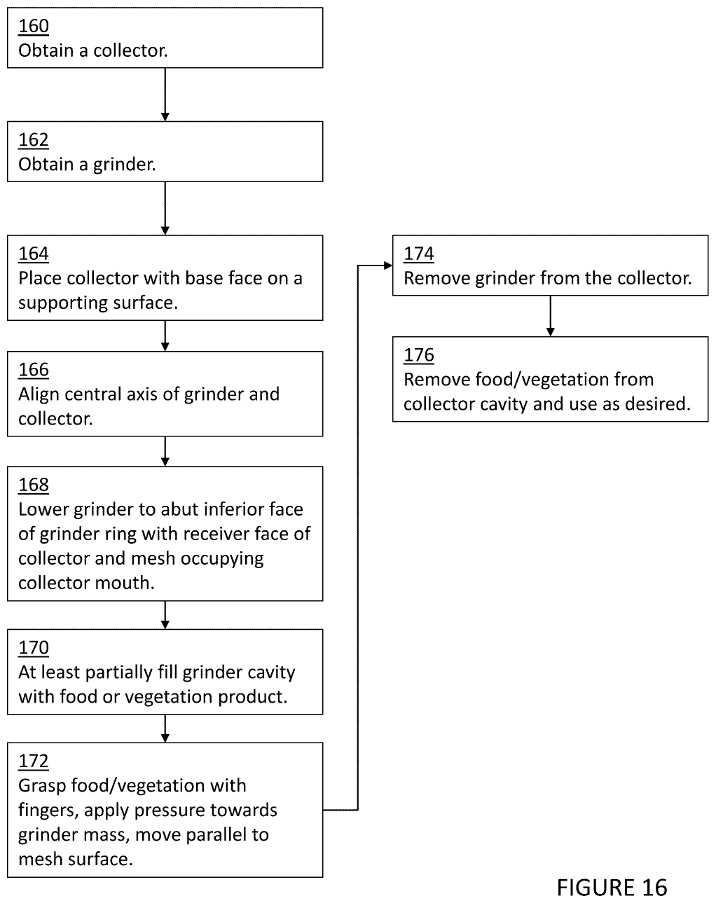

In one form, a preferred embodiment for a method of using a hand vegetation grinder assembly as disclosed herein comprises the following steps as illustrated in FIG. 16. Obtaining a collector having a collector wall defining a substantially enclosed collector cavity, a base face for supporting the collector on a horizontal supporting surface such as a countertop, and a receiver face that defines a collector mouth for supporting a grinder and provides entry into the collector cavity (160). Obtaining a grinder comprising a grinder ring with a generally semi-spherical grinder mesh made of woven wire and wherein a fixation face of the grinder mesh is fixed to an inferior face of the grinder ring (162). Placing the base face of the collector on the supporting surface (164) (operable mode). Aligning the central axis of the grinder with the central axis of the collector (166) and lowering the grinder such that the inferior face of the grinder ring is seated on the receiver face of the collector and the grinder mesh occupies the collector mouth of the collector (168). At least partially filling the grinder cavity with food or other vegetation product such as a vegetation mass (170). Grasping the vegetation mass with the user's fingers and applying pressure to the vegetation towards the grinder mesh while moving the vegetation parallel to the mesh surface causing consequent shearing of pieces of the vegetation to fall through the mesh openings and collect in the collector cavity (172). Removing the grinder from the collector (174). Removing the food/vegetation shreds from the collector cavity and utilizing the ground food or vegetation product as desired (176).

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. (canceled)

2. (canceled)

3. A method of grinding vegetation comprising:
obtaining a collector wherein said collector comprises a collector wall defining a collector cavity operable to collect vegetation therein that falls through a collector mouth that extends through an upward facing receiver face of the collector;
obtaining a grinder comprising a grinder ring having a substantially flat inferior face and superior face with a grinder mesh comprising woven wire bulging inferiorly from the grinder ring defining a grinder cavity encircled by the grinder mesh;
aligning a central axis of the collector with a central axis of the grinder;
lowering the grinder onto the collector such that the inferior face of the grinder ring is seated on the receiver face of the collector with the mesh bulging into the collector mouth;
at least partially filling the grinder cavity with a vegetation mass; and
applying force against the vegetation mass moving it into and parallel to the mesh surface.

4. The method of claim 3 wherein the step of applying force against the vegetation mass moving it parallel to the mesh surface utilizes finger pressure to apply the force.

5. The method of claim 3 further comprising the step of shearing vegetation shreds from the vegetation mass due to movement of the vegetation mass across the grinder mesh.

6. The method of claim 5 further comprising the step of the vegetation shreds falling towards the bottom of the collector.

7. The method of claim 6 further comprising the step of:
removing the grinder from the collector.

8. The method of claim 7 further comprising the step of:
removing the vegetation shreds accumulated in the collector cavity.

9. A hand vegetation grinder assembly in an operable mode comprising:
a grinder;
said grinder comprising a grinder ring;
said grinder comprising a bulbous mesh;
said bulbous mesh fixed to said grinder ring;
said bulbous mesh bulging downward from said grinder ring;
a collector;
said collector comprising an encircling collector wall defining a collector cavity within said collector wall;
said collector comprising a collector mouth;
said collector mouth leading into said collector cavity;
said grinder and said collector aligned; and
wherein said grinder ring is seated on said collector mouth with said bulbous mesh extending into said collector mouth.

10. The hand vegetation grinder assembly of claim 9 wherein said bulbous mesh is welded to said grinder ring.

11. The hand vegetation grinder assembly of claim 9 wherein said bulbous mesh is crimped to said grinder ring.

12. The hand vegetation grinder assembly of claim 9 wherein said bulbous mesh comprises a woven wire.

13. The hand vegetation grinder assembly of claim 9 further comprising:
said grinder ring having a superior face facing superior;
said grinder ring having an inner face facing inward; and,
wherein said grinder ring comprises a radiused edge transitioning between said superior face and said inner face.

14. The hand vegetation grinder assembly of claim 9 further comprising:
a mesh flange on said grinder ring;
said mesh flange defined by a superior crimp face facing inferiorly;
said mesh flange defined by an inferior crimp face facing superiorly;
an inter-crimp face extending between said superior crimp face and said inferior crimp face; and,
wherein a portion of said grinder mesh is crimped between said superior crimp face and said inferior crimp face.

15. The hand vegetation grinder assembly of claim 9 further comprising:
a lid;
wherein said lid comprises a closure cavity operable to encircle and enclose said collector mouth.

16. The hand vegetation grinder assembly of claim 15 wherein said grinder ring is sized to fit in said closure cavity.

17. The hand vegetation grinder assembly of claim 15 wherein said closure cavity comprises inner threads.

18. The hand vegetation grinder assembly of claim 15 wherein said collector is encircled with external threads just below said collector mouth.

19. The hand vegetation grinder assembly of claim 9 wherein the external diameter of said grinder ring is substantially the same as said outer collector surface at said collector mouth.

20. The hand vegetation grinder assembly of claim 9 wherein said bulbous mesh is substantially hemi-spherical in shape.

21. The hand vegetation grinder assembly of claim 9 wherein said grinder ring has a diameter sized to overlap said collector mouth.

22. The hand vegetation grinder assembly of claim 9 wherein said grinder mesh has steeply sloped sides that curve inward to an inferior point.
